(19) United States
(12) Patent Application Publication
(10) Pub. No.: US 2026/0108871 A1
(43) Pub. Date: Apr. 23, 2026

(54) METHOD FOR PREPARING SCHIFF BASE-MODIFIED IONIC FRAMEWORK MATERIAL AND USE THEREOF IN ADVANCED PURIFICATION OF 177 LU-CONTAINING MEDICAL WASTEWATER

(71) Applicant: Southwest University of Science and Technology, Mianyang (CN)

(72) Inventors: Xiaoqin NIE, Mianyang (CN); Yunlong ZHANG, Mianyang (CN); Guohao ZHANG, Mianyang (CN); Qiuhong ZHU, Mianyang (CN); Ning PAN, Mianyang (CN); Yilin QIN, Mianyang (CN); Liuyuan FU, Mianyang (CN); Linze XIAO, Mianyang (CN)

(73) Assignee: Southwest University of Science and Technology, Mianyang (CN)

(21) Appl. No.: 19/326,590

(22) Filed: Sep. 11, 2025

(30) Foreign Application Priority Data
Oct. 17, 2024 (CN) 2024114532619

(51) Int. Cl. B01J 39/26; B01D 15/36; B01J 39/04; B01J 39/16; B01J 47/016; B01J 47/022; G21F 9/12

(52) U.S. Cl. CPC B01J 39/26; B01D 15/362; B01J 39/04; B01J 39/16; B01J 47/016; B01J 47/022; G21F 9/12

(57) ABSTRACT

Disclosed are a method for preparing a Schiff base-modified ionic framework material and use thereof in advanced purification of ¹⁷⁷Lu-containing medical wastewater, including: using a conventional sponge as a substrate material and employing the Schiff base reaction principle with an amine-based reagent as a “bridge” and an aldehyde-based reagent as an active excitation reaction monomer to prepare an amino acid-based metal ionic Schiff base-modified ionic framework material by a one-pot synthesis method; and packing the Schiff base-modified ionic framework material in a chromatographic column for the advanced purification of the ¹⁷⁷Lu-containing medical wastewater. The material preparation process of this disclosure is simple with stable performance, and the functionalized modified material possesses ion exchange functionality, exhibiting superior adsorption performance for metal cations. Furthermore, the combined process method of this disclosure demonstrates good treatment effects on the ¹⁷⁷Lu-containing medical wastewater.

### CROSS-REFERENCE TO RELATED APPLICATIONS

The application claims priority to Chinese patent application No. 2024114532619, filed on Oct. 17, 2024, the entire contents of which are incorporated herein by reference.

### TECHNICAL FIELD

This disclosure relates to the technical field of wastewater treatment and, in particular, to a method for preparing a Schiff base-modified ionic framework material and use thereof in advanced purification of ¹⁷⁷Lu-containing medical wastewater.

### BACKGROUND

With the advancement of modern medicine, the application of nuclear medicine in hospitals for medical diagnosis and treatment has become increasingly widespread. As the usage of medical isotopes grows, the existing natural decay method adopted by hospitals can no longer meet the demands of modern nuclear medicine development. The natural decay method relies on decay tanks for storing radioactive liquid waste, allowing it to undergo natural decay over a storage period exceeding ten times the longest half-life of the radionuclides. Consequently, this method presents problems such as large space occupation by decay tanks, limited single-batch processing capacity, and prolonged liquid waste storage cycles. These problems have become critical technical problems urgently requiring solutions in the rapid development of China's nuclear medicine field. Currently, ¹⁷⁷Lu-labeled drugs have demonstrated significant clinical advantages in the treatment of prostate cancer and neurogenic tumors. However, the method for treating ¹⁷⁷Lu-containing medical wastewater still relies on natural decay.

This disclosure employs a one-pot synthesis method to obtain a novel Schiff base-modified framework material, which effectively adsorbs lutetium at an extremely fast adsorption rate and presents high adsorption capacity. As a new generation of environmentally friendly material, it holds great application potential and socio-economic benefits.

### SUMMARY

An objective of this disclosure is to address at least the aforementioned problems and/or deficiencies and to provide at least the advantages that will be discussed hereafter.

To achieve these objectives and advantages according to this disclosure, a Schiff base-modified ionic framework material is provided, having the following structural formula:

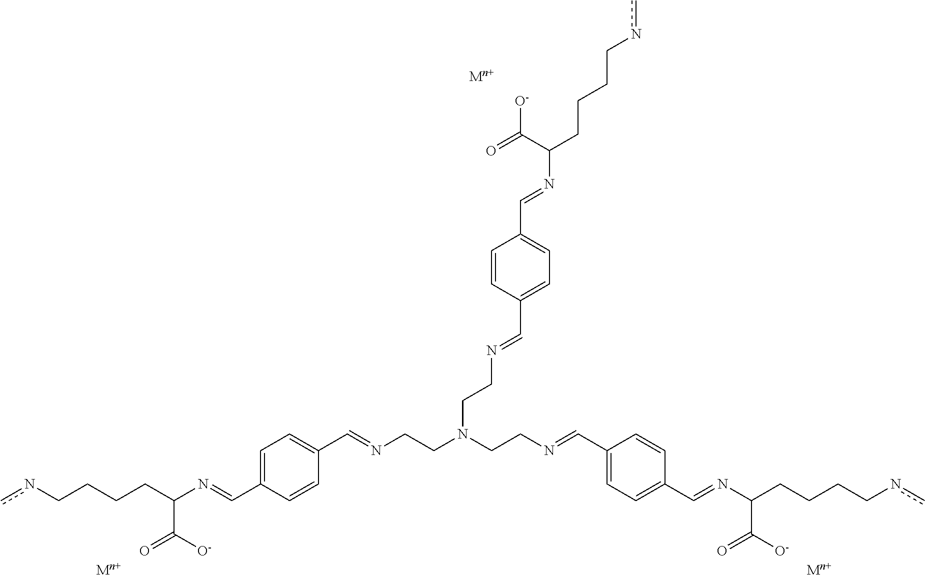

where M represents one or a combination of metal cations including sodium, potassium, magnesium, calcium, aluminum, and iron; and n represents an integer from 1 to 3.

A method for preparing the Schiff base-modified ionic framework material is further provided, including the following steps:
S1: cutting a sponge substrate into cuboids with a length of 5-20 mm and a width and thickness of 5-10 mm to obtain an unmodified sponge substrate; immersing the sponge substrate in absolute ethanol, performing oscillation in an ultrasonic oscillator for 20-30 min, and repeating 2-3 times to remove impurities; and drying for later use;
S2: adding an amine compound and an aldehyde compound in appropriate amounts to an organic solvent for reaction at room temperature for a certain duration; subsequently adding ethyl acetate and dichloromethane in appropriate amounts for reaction to proceed statically at room temperature for 10-30 min to obtain a precursor solution; then adding an amino acid-based metal ionic liquid in a certain amount to the precursor solution, and performing oscillation using an oscillator to ensure complete dissolution; and finally allowing a resulting mixture to stand at room temperature for 5-10 min to obtain a functionalized reagent; and
S3: immersing the sponge substrate from the step S1 in the functionalized reagent in the step S2; allowing for reaction to proceed statically at a certain temperature for a certain duration while shaking every 2-5 min during the reaction; and drying to obtain the Schiff base-modified ionic framework material.

Preferably, in the step S2, the organic solvent includes but is not limited to any one of acetone, acetonitrile, ethanol, and dimethyl sulfoxide, or a combination thereof; the amine compound includes but is not limited to any one of ethylenediamine, triethylenetetramine, diethylenetriamine, tris(2-aminoethyl)amine, and cyclohexanediamine, or a combination thereof; and the aldehyde compound includes but is not limited to any one of triformylbenzene, terephthalaldehyde, isophthalaldehyde, and phthalaldehyde, or a combination thereof.

Preferably, in the step S2, the amino acid-based metal ionic liquid includes but is not limited to any one of lysine-, glycine-, ornithine-, cystine-, and arginine-based metal ionic liquids, or a combination thereof, and contains a metal ion including, but not limited to, any one of sodium, potassium, magnesium, calcium, aluminum, and iron, or a combination thereof.

Preferably, in the step S2, a volume of the organic solvent is 5-10 mL; a molar ratio of the amine compound to the aldehyde compound is 2:5; a molar-volume ratio of the amine compound to the organic solvent is (0.3-0.5 mmol):(5-10 mL); and the reaction duration is 5-15 min.

Preferably, in the step S2, a volume ratio between the ethyl acetate, the dichloromethane, and the organic solvent is 1:1:8; a mass ratio of the precursor solution to the amino acid-based metal ionic liquid ranges from 50:1 to 100:1; a rotational speed of the oscillator is set to 250-300 r/min; and an oscillation duration is 5-10 min.

Preferably, in the step S3, a mass-volume ratio of the sponge substrate to the functionalized reagent ranges from (0.015 g):(10 mL) to (0.03 g):(10 mL); the reaction temperature is 20-30° C.; and the reaction duration is 5-20 min.

A method for advanced purification of ¹⁷⁷Lu-containing medical wastewater using the Schiff base-modified ionic framework material, including: packing the Schiff base-modified ionic framework material into a single-stage or multi-stage glass chromatographic column via wet filling, where a mass ratio of the ¹⁷⁷Lu-containing medical wastewater to the Schiff base-modified ionic framework material ranges from 10:1 to 1000:1; and performing adsorption in series and/or parallel configuration, where the ¹⁷⁷Lu-containing medical wastewater is introduced into the glass chromatographic column in a bottom-in/top-out manner at a flow rate of 0.01-100 L/h controlled by adjusting a peristaltic pump.

Preferably, the glass chromatographic column has dimensions of length 5-200 cm, inner diameter 1-100 cm, and outer diameter 2-110 cm; and the ¹⁷⁷Lu-containing medical wastewater has a lutetium concentration ranging from 0.01 mg/L to 50 mg/L. This disclosure has at least the following beneficial effects:
(1) using a polyurethane sponge, melamine sponge, polyvinyl alcohol sponge, polyester sponge, carboxymethyl cellulose sponge, polypropylene sponge, or the like as a substrate material, and employing the Schiff base reaction principle with an amine-based reagent as a “bridge” and an aldehyde-based reagent as an active excitation reaction monomer, a novel amino acid-based metal ionic Schiff base-modified ionic framework material is prepared by a one-pot synthesis method, and the material is packed in a chromatographic column for advanced purification of ¹⁷⁷Lu-containing medical wastewater. The material preparation process of this disclosure is simple with stable performance, and the functionalized modified material possesses ion exchange functionality, exhibiting superior adsorption performance for metal cations. Furthermore, the combined process method of this disclosure demonstrates good treatment effects on the ¹⁷⁷Lu-containing medical wastewater, exhibits degradability, and is environmentally friendly;
(2) the modified material exhibits a planar spatial structure and is capable of forming dense membrane layers within the pores of the sponge substrate, providing a large contact area and a fast adsorption rate;
(3) after modification, the sponge acquires ion exchange functionality, demonstrating good treatment effects on actual ¹⁷⁷Lu-containing medical wastewater, and the modified sponge exhibits stable physicochemical properties;
(4) the synthesis method for the novel Schiff base-modified framework material provided by this disclosure is simple and easy to operate, requiring no introduction of other external conditions, thereby enabling batch synthesis; and
(5) the operation of the apparatus used in this disclosure requires no additional chemicals, introduces no new impurities, and generates minimal subsequent waste.

The advantages, objectives, and features of this disclosure will be partially embodied in the following description and partially understood by those skilled in the art through study and practice of this disclosure.

### BRIEF DESCRIPTION OF THE DRAWINGS

FIG. 1 is a schematic structural view of a wastewater treatment apparatus provided in this disclosure;

FIG. 2 is an SEM image of a Schiff base-modified ionic framework material prepared in Example 1 of this disclosure;

FIG. 3 is a time gradient graph of lutetium ion adsorption by the Schiff base-modified ionic framework material prepared in Example 1 of this disclosure; and

FIG. 4 is a concentration gradient graph of lutetium ion adsorption by the Schiff base-modified ionic framework material prepared in Example 1 of this disclosure.

### DETAILED DESCRIPTION OF THE EMBODIMENTS

This disclosure will be further described in detail below in conjunction with the accompanying drawings to enable those skilled in the art to implement it with reference to the specification.

It should be understood that the terms “comprise”, “include”, “have”, and the like as used herein do not exclude the presence or addition of one or more other elements or combinations thereof.

### Example 1

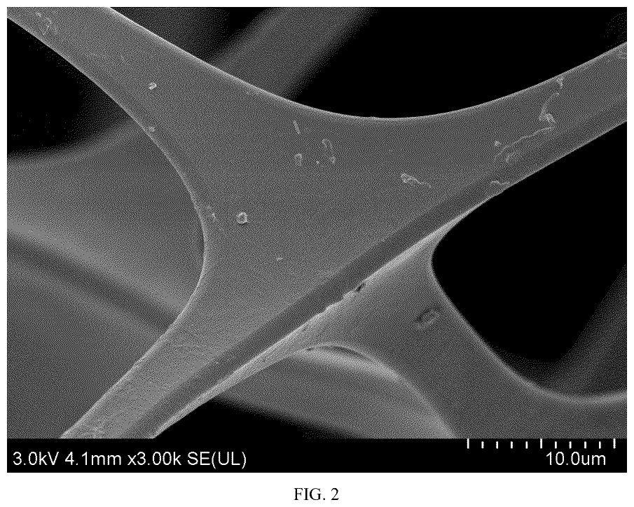

This example provides a method for advanced purification of ¹⁷⁷Lu-containing medical wastewater using a Schiff base-modified ionic framework material, including the following steps:
Step I: preparing the Schiff base-modified ionic framework material Lys-Na@MF, specifically including:
S1: cutting an original sponge into cuboids with a length of 10 mm and a width and thickness of 5 mm to obtain an unmodified sponge substrate;
S2: immersing the sponge substrate in absolute ethanol, then placing it in an ultrasonic oscillator and performing oscillation for 20 min, repeating this process 3 times to remove potential impurities, and finally drying in an oven at 50° C.;
S3: synthesizing a functionalized reagent at room temperature, where the functionalized reagent is prepared by the following steps: adding 1 mmol of tris(2-aminoethyl)amine and 2.5 mmol of terephthalaldehyde to 14 mL of ethanol as a solvent, and allowing for reaction for 10 min; then taking 5 mL of the reacted reagent into a reactor, adding ethyl acetate and dichloromethane in an amount of 1 mL respectively, and allowing for standing at room temperature for 10 min; subsequently adding 0.2 mmol of lysine-sodium ionic liquid, placing the resulting mixture on an oscillator, and performing oscillation at a rotational speed of 250 r/min for 10 min to ensure complete dissolution in the reagent; and finally allowing for standing at room temperature for 10 min to obtain the functionalized reagent; and
S4: loading the functionalized reagent onto the sponge substrate; then placing 15 mg of the cleaned and dried sponge substrate into 10 mL of the functionalized reagent, and allowing for reaction to proceed statically at room temperature for 15 min while shaking every 3 min during the reaction to obtain a Schiff base-modified sponge; subsequently taking out and drying the sponge in an oven at 60° C., and turning over the sponge every 5 min during the drying process to obtain the Schiff base-modified ionic framework material Lys-Na@MF. The SEM image of the Schiff base-modified ionic framework material prepared in this example is shown in FIG. 2;
Step II: placing 20 g of the dried Schiff base-modified ionic framework material into a glass chromatographic column, and passing absolute ethanol completely through the glass chromatographic column containing the Schiff base-modified ionic framework material until the Schiff base-modified ionic framework material is fully saturated by the absolute ethanol; and
Step III: introducing, through a peristaltic pump adjusted at a flow rate of 2 mL/min, the ¹⁷⁷Lu-containing medical wastewater into a glass chromatographic column with an inner diameter of 5 cm and an effective height of 20 cm, and collecting the treated wastewater to complete the advanced purification of the ¹⁷⁷Lu-containing medical wastewater. In this example, the initial concentration of lutetium in the ¹⁷⁷Lu-containing medical wastewater was 10 mg/L, with a wastewater volume of 1 L. After the purification, the concentration of lutetium was reduced to 0.04 mg/L.

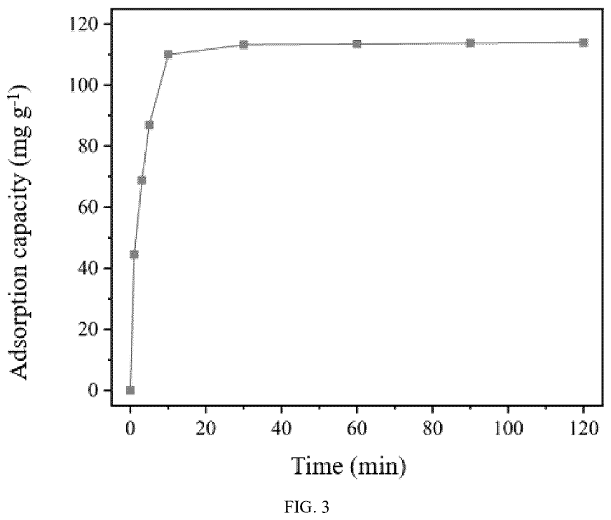

As shown in FIG. 3, at room temperature (25° C.), 15 mg of the Schiff base-modified ionic framework material prepared in this example was added to 25 mL of lutetium solution with a lutetium concentration of 100 mg/L (pH=6.7). The curve of adsorption capacity over time demonstrates that the Schiff base-modified ionic framework material achieves rapid lutetium adsorption, reaching equilibrium within approximately 10 min.

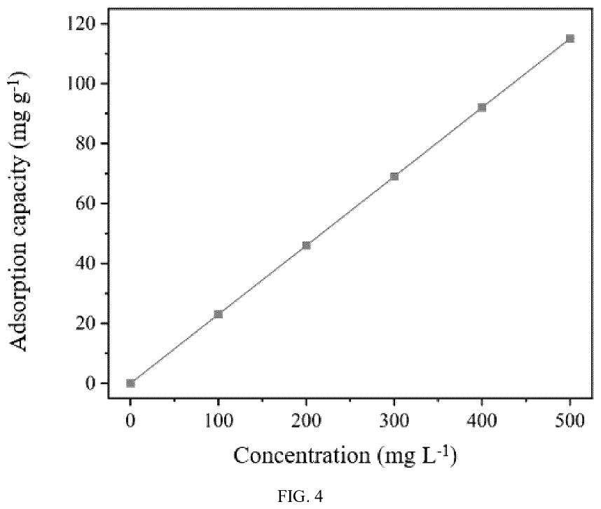

As shown in FIG. 4, at room temperature (25° C.), 15 mg of the Schiff base-modified ionic framework material prepared in this example was added to 25 mL of lutetium solutions at varying concentrations (pH=6.7) with an adsorption duration of 6 h. The curve of adsorption capacity changing with lutetium ion concentration in the solutions indicates that the Schiff base-modified ionic framework material maintains good adsorption performance even for high-concentration lutetium ion solutions.

### Example 2

This example provides a method for advanced purification of ¹⁷⁷Lu-containing medical wastewater using a Schiff base-modified ionic framework material, including the following steps:
Step I: preparing the Schiff base-modified ionic framework material Lys-Na@MF, specifically including:
S1: cutting an original sponge into cuboids with a length of 15 mm and a width and thickness of 10 mm to obtain an unmodified sponge substrate;
S2: immersing the sponge substrate in absolute ethanol, then placing it in an ultrasonic oscillator and performing oscillation for 20 min, repeating this process 3 times to remove potential impurities, and finally drying in an oven at 50° C.;
S3: synthesizing a functionalized reagent at room temperature, where the functionalized reagent is prepared by the following steps: adding 0.5 mmol of tris(2-aminoethyl)amine and 1.25 mmol of terephthalaldehyde to 7 mL of ethanol as a solvent, and allowing for reaction for 10 min; then taking 5 mL of the reacted reagent into a reactor, adding ethyl acetate and dichloromethane in an amount of 1 mL respectively, and allowing for standing at room temperature for 20 min; subsequently adding 0.2 mmol of lysine-sodium ionic liquid, placing the resulting mixture on an oscillator, and performing oscillation at a rotational speed of 250 r/min for 10 min to ensure complete dissolution in the reagent; and finally allowing for standing at room temperature for 10 min to obtain the functionalized reagent; and
S4: loading the functionalized reagent onto the sponge substrate; then placing 15 mg of the cleaned and dried sponge substrate into 10 mL of the functionalized reagent, and allowing for reaction to proceed statically at room temperature for 20 min while shaking every 5 min during the reaction to obtain a Schiff base-modified sponge; subsequently taking out and drying the sponge in an oven at 60° C., and turning over the sponge every 5 min during the drying process to obtain the Schiff base-modified ionic framework material;
Step II: placing 20 g of the dried Schiff base-modified ionic framework material into a glass chromatographic column, and passing absolute ethanol completely through the glass chromatographic column containing the Schiff base-modified ionic framework material until the Schiff base-modified ionic framework material is fully saturated by the absolute ethanol; and
Step III: introducing, through a peristaltic pump adjusted at a flow rate of 5 mL/min, the ¹⁷⁷Lu-containing medical wastewater into a glass chromatographic column with an inner diameter of 5 cm and an effective height of 20 cm, and collecting the treated wastewater to complete the advanced purification of the ¹⁷⁷Lu-containing medical wastewater. In this example, the initial concentration of lutetium in the ¹⁷⁷Lu-containing medical wastewater was 10 mg/L, with a wastewater volume of 1 L. After the purification, the concentration of lutetium was reduced to 0.10 mg/L.

### Example 3

This example provides a method for advanced purification of ¹⁷⁷Lu-containing medical wastewater using a Schiff base-modified ionic framework material, including the following steps:
Step I: preparing the Schiff base-modified ionic framework material Lys-Na@MF, specifically including:
S1: cutting an original sponge into cuboids with a length of 20 mm and a width and thickness of 10 mm to obtain an unmodified sponge substrate;
S2: immersing the sponge substrate in absolute ethanol, then placing it in an ultrasonic oscillator and performing oscillation for 30 min, repeating this process 3 times to remove potential impurities, and finally drying in an oven at 50° C.;
S3: synthesizing a functionalized reagent at room temperature, where the functionalized reagent is prepared by the following steps: adding 0.5 mmol of tris(2-aminoethyl)amine and 1.25 mmol of terephthalaldehyde to 14 mL of ethanol as a solvent, and allowing for reaction for 20 min; then taking 10 mL of the reacted reagent into a reactor, adding ethyl acetate and dichloromethane in an amount of 1 mL respectively, and allowing for standing at room temperature for 20 min; subsequently adding 0.2 mmol of lysine-sodium ionic liquid, placing the resulting mixture on an oscillator, and performing oscillation at a rotational speed of 250 r/min for 10 min to ensure complete dissolution in the reagent; and finally allowing for standing at room temperature for 20 min to obtain the functionalized reagent; and
S4: loading the functionalized reagent onto the sponge substrate; then placing 15 mg of the cleaned and dried sponge into 10 mL of the functionalized reagent, and allowing for reaction to proceed statically at room temperature for 30 min while shaking every 5 min during the reaction to obtain a Schiff base-modified sponge; subsequently taking out and drying the sponge in an oven at 60° C., and turning over the sponge every 5 min during the drying process to obtain the Schiff base-modified ionic framework material;
Step II: placing 20 g of the dried Schiff base-modified ionic framework material into a glass chromatographic column, and passing absolute ethanol completely through the glass chromatographic column containing the Schiff base-modified ionic framework material until the Schiff base-modified ionic framework material is fully saturated by the absolute ethanol; and
Step III: introducing, through a peristaltic pump adjusted at a flow rate of 5 mL/min, the ¹⁷⁷Lu-containing medical wastewater into a glass chromatographic column with an inner diameter of 5 cm and an effective height of 20 cm, and collecting the treated wastewater to complete the advanced purification of the ¹⁷⁷Lu-containing medical wastewater. In this example, the initial concentration of lutetium in the ¹⁷⁷Lu-containing medical wastewater was 10 mg/L, with a wastewater volume of 1 L. After the purification, the concentration of lutetium was reduced to 0.08 mg/L.

### Example 4

Volume reduction treatment was performed on the Schiff base-modified ionic framework material that had completed the advanced purification of the ¹⁷⁷Lu-containing medical wastewater in Example 1, specifically including the following steps:
weighing 1.0 g each of the original Schiff base-modified ionic framework material and the lutetium-adsorbed Schiff base-modified ionic framework material; placing each of the samples separately in a crucible and subjecting them to volume reduction treatment in a muffle furnace. The muffle furnace was set as follows: first heating at a heating rate of 8° C./min for 100 min until reaching 800° C., and then holding at 800° C. for 300 min.

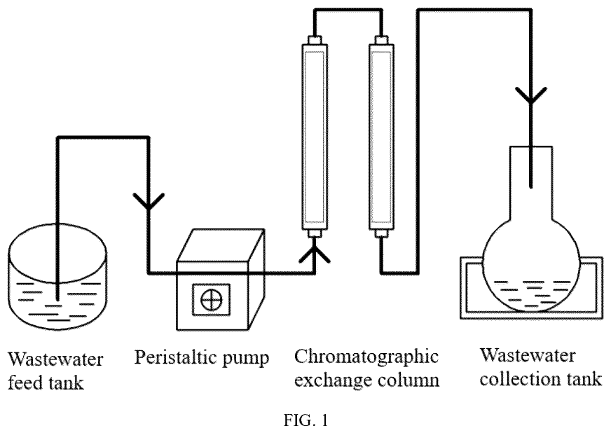

The apparatus used for the advanced purification of the ¹⁷⁷Lu-containing medical wastewater in Examples 1-3 is shown in FIG. 1, including:
a wastewater feed tank connected through piping to a peristaltic pump;
a two-stage glass chromatographic exchange column, with a lower end of a first-stage glass chromatographic exchange column connected through piping to the peristaltic pump and an upper end of a second-stage glass chromatographic exchange column connected to a wastewater collection tank; and
the wastewater collection tank, with an inlet connected through piping to the glass chromatographic exchange column and an outlet connected to an intelligent peristaltic pump;
where the wastewater feed tank was configured to contain the ¹⁷⁷Lu-containing medical wastewater, which was pumped by the peristaltic pump into the two-stage glass chromatographic exchange column for chromatographic purification; and the wastewater entered the two-stage glass chromatographic exchange column from the lower end of the first-stage glass chromatographic exchange column and exited from the upper end of the second-stage glass chromatographic exchange column into the wastewater collection tank. The entire purification apparatus, combined with the use of the Schiff base-modified ionic framework material, achieved the advanced purification of the ¹⁷⁷Lu-containing medical wastewater, enabling the final effluent lutetium concentration to be ≤0.10 mg/L.

The number of devices and processing scales described herein are intended to simplify the description of this disclosure. Applications, modifications, and variations of this disclosure are apparent to those skilled in the art.

Although the embodiments of this disclosure are disclosed above, the embodiments are not limited to the applications listed in the specification and the implementations but totally can be applied to various fields to which this disclosure is applicable. For those skilled in the art, other modifications can be easily made. Therefore, without departing from the general concepts defined in the claims and equivalent ranges, this disclosure is not limited to particular details and drawings shown and described herein.

What is claimed is:

1. A method for advanced purification of ¹⁷⁷Lu-containing medical wastewater using a Schiff base-modified ionic framework material, comprising: packing the Schiff base-modified ionic framework material into a single-stage or multi-stage glass chromatographic column via wet filling, wherein a mass ratio of the ¹⁷⁷Lu-containing medical wastewater to the Schiff base-modified ionic framework material ranges from 10:1 to 1000:1; and performing adsorption in series and/or parallel configuration, wherein the ¹⁷⁷Lu-containing medical wastewater is introduced into the glass chromatographic column in a bottom-in/top-out manner at a flow rate of 0.01-100 L/h controlled by adjusting a peristaltic pump;
wherein a method for preparing the Schiff base-modified ionic framework material comprises:
S1: cutting a sponge substrate into cuboids with a length of 5-20 mm and a width and thickness of 5-10 mm; immersing the sponge substrate in absolute ethanol, performing oscillation in an ultrasonic oscillator for 20-30 min, and repeating 2-3 times to remove impurities; and drying for later use;
S2: adding an amine compound and an aldehyde compound to an organic solvent for reaction at room temperature: adding ethyl acetate and dichloromethane for reaction to proceed statically at room temperature for 10-30 min to obtain a precursor solution; and
adding an amino acid-based metal ionic liquid to the precursor solution, performing oscillation using an oscillator, and allowing a resulting mixture to stand at room temperature for 5-10 min to obtain a functionalized reagent, wherein the organic solvent comprises any one of acetone, acetonitrile, ethanol, and dimethyl sulfoxide, or a combination thereof: the amine compound is tris(2-aminoethyl)amine; the aldehyde compound is terephthalaldehyde; and the amino acid-based metal ionic liquid is a lysine-based metal ionic liquid and contains a metal ion being any one of sodium, potassium, magnesium, calcium, aluminum, and iron, or a combination thereof; and
S3: immersing the sponge substrate in the functionalized reagent; allowing for reaction to proceed statically at 20-30° C. for 5-20 min while shaking every 2-5 min during the reaction; and drying to obtain the Schiff base-modified ionic framework material, wherein a dosage ratio of the sponge substrate to the functionalized reagent ranges from (0.015 g):(10 mL) to (0.03 g):(10 mL);
wherein a structural formula of the Schiff base-modified ionic framework material is as follows: 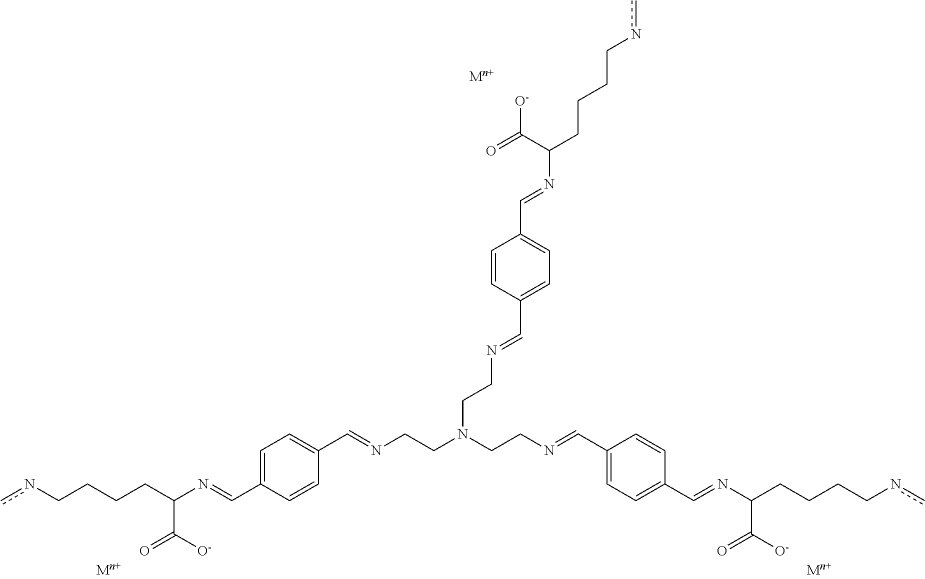
wherein M represents one or a combination of metal cations comprising sodium, potassium, magnesium, calcium, aluminum, and iron; and n represents an integer from 1 to 3.

2. The method for the advanced purification of the ¹⁷⁷Lu-containing medical wastewater using the Schiff base-modified ionic framework material according to claim 1, wherein in the step S2, a volume of the organic solvent is 5-10 mL; a molar ratio of the amine compound to the aldehyde compound is 2:5; a molar-volume ratio of the amine compound to the organic solvent is (0.3-0.5 mmol):(5-10 mL); and a reaction duration is 5-15 min.

3. The method for the advanced purification of the ¹⁷⁷Lu-containing medical wastewater using the Schiff base-modified ionic framework material according to claim 1, wherein in the step S2, a volume ratio between the ethyl acetate, the dichloromethane, and the organic solvent is 1:1:8; a mass ratio of the precursor solution to the amino acid-based metal ionic liquid ranges from 50:1 to 100:1; a rotational speed of the oscillator is set to 250-300 r/min; and an oscillation duration is 5-10 min.

4. The method for the advanced purification of the ¹⁷⁷Lu-containing medical wastewater using the Schiff base-modified ionic framework material according to claim 1, wherein the glass chromatographic column has dimensions of length 5-200 cm, inner diameter 1-100 cm, and outer diameter 2-110 cm; and the ¹⁷⁷Lu-containing medical wastewater has a lutetium concentration ranging from 0.01 mg/L to 50 mg/L.
